(19) United States
(12) Patent Application Publication
(10) Pub. No.: US 2024/0018358 A1
(43) Pub. Date: Jan. 18, 2024

(54) POLYSILOXANE-BASED RESIN AND UTILIZATION THEREOF

(71) Applicant: KANEKA CORPORATION, Osaka (JP)

(72) Inventor: Hiroyuki Yokoi, Hyogo (JP)

(73) Assignee: KANEKA CORPORATION, Osaka (JP)

(21) Appl. No.: 18/470,549

(22) Filed: Sep. 20, 2023

Related U.S. Application Data
(63) Continuation of application No. PCT/JP2022/009848, filed on Mar. 8, 2022.

(30) Foreign Application Priority Data
Mar. 22, 2021 (JP) 2021-047708

(51) Int. Cl. C08L 83/06; C08F 290/14; C09D 183/06

(52) U.S. Cl. CPC C08L 83/06; C08F 290/148; C09D 183/06; C08L 2201/52; C08L 2205/03; C08L 2205/05

(57) ABSTRACT

A polysiloxane-based resin that can be stably dispersed or dissolved in an aqueous medium and that has an appropriate level of viscosity, when made into a solution, is provided. The polysiloxane-based resin contains a polymer containing, as a structural unit, a structural unit derived from a monomer having a radically polymerizable group. The monomer includes (i) a monomer that is soluble in water and forms no micelles in water and (ii) a monomer that is capable of forming micelles in water.

### TECHNICAL FIELD

One or more embodiments of the present invention relate to a polysiloxane-based resin and use thereof.

### BACKGROUND

Paints containing polysiloxane are known to be paints form which a coating film exhibiting a high durability can be obtained. For example, Patent Literature 1 discloses a curable resin composition (paint) containing: resin obtained by a condensation reaction between a polymer having a hydrolyzable silyl group and polysiloxane having a hydroxyl group bonded to a silicon atom; and a curing catalyst.

### PATENT LITERATURE

[Patent Literature 1]
Japanese Patent Application Publication Tokukaihei No. 9-176489

Patent Literature 1 described above pertains to a paint containing an organic solvent. However, in recent years, the field of paints has also adopted the viewpoint of pollution prevention and resource conservation, and attempts have been made to make a shift from paints that use an organic solvent to paints that use a water-soluble or water-dispersible resin.

However, since polysiloxane-based resins are hydrophobic, it is difficult to render polysiloxane-based resins aqueous. Further, to use a polysiloxane-based resin in the form of paint, it is necessary that the aqueous product has a viscosity within a range suitable for actual use.

### SUMMARY

One or more embodiments of the present invention provide a polysiloxane-based resin that can be stably dispersed or dissolved in an aqueous medium (can be rendered aqueous) and, when rendered aqueous, has an appropriate level of viscosity.

The inventors of one or more embodiments of the present invention conducted a diligent study and discovered for the first time that, by adding, as structural units of side chains that bind to a main chain consisting of polysiloxane in a polysiloxane-based resin, a structural unit derived from a monomer that is soluble in water and forms no micelles in water and a structural unit derived from a monomer that is capable of forming micelles in water, it is possible to (1) obtain a polysiloxane-based resin that can be stably dispersed or dissolved in an aqueous medium (can be rendered aqueous) and (2) obtain, when the polysiloxane-based resin is rendered aqueous, a solution or dispersion slurry having an appropriate level of viscosity. On the basis of the finding, the inventors of one or more embodiments of the present invention completed one or more embodiments of the present invention.

Thus, an aspect of one or more embodiments of the present invention is a polysiloxane-based resin containing a polymer containing, as a structural unit, a structural unit derived from a monomer having a radically polymerizable group, the monomer including (i) a monomer that is soluble in water and forms no micelles in water and (ii) a monomer that is capable of forming micelles in water.

An aspect of one or more embodiments of the present invention makes it possible to provide a polysiloxane-based resin that can be stably dispersed or dissolved in an aqueous medium (can be rendered aqueous) and, when rendered aqueous, has an appropriate level of viscosity.

### DETAILED DESCRIPTION

The following description will discuss one or more embodiments of the present invention in detail. Any numerical range expressed as “A to B” in the present disclosure means “not less than A and not more than B”, unless otherwise stated. All the documents cited in the present specification are incorporated herein by reference.

[1. Overview of One or More Embodiments of the Present Invention]

Polysiloxane-based resins have, in a main chain thereof, a siloxane bond having a high binding energy. As such, when a polysiloxane-based resin is used as a resin for paint, a high weather resistance is expected to be exhibited. Further, water-based paints containing water as a medium have high market needs due to having little adverse effects on the human body and the environment. These are combined into water-based polysiloxane resins, which have been attracting attention due to having little environmental load and exhibiting high weather resistance. However, it is difficult for polysiloxane-based resins, which are hydrophobic, to be rendered aqueous.

Meanwhile, the inventors of one or more embodiments of the present invention had previously found that, by adding a salt structure consisting of an acid and a base in a polysiloxane-based resin, it is possible to obtain a water-soluble polysiloxane-based resin. While conducting further research on the above technique, the inventors of one or more embodiments of the present invention found the followings:

In a case where a salt structure consisting of an acid and a base is added to a polysiloxane-based resin, the polysiloxane-based resin becomes soluble in water. However, a solution in which the polysiloxane-based resin has been dissolved has a significantly increased viscosity, and therefore cannot be used for applications such as water-based paint.

As such, the inventors of one or more embodiments of the present invention conducted a diligent study on a method that can simultaneously attain the above objects of solubility and viscosity, and consequently succeeded in obtaining the following findings:

In a polysiloxane-based resin, by adding, as structural units of side chains, structural units respectively derived from the following monomers (i) and (ii), it is possible to obtain a polysiloxane-based resin that can be stably dispersed or dissolved in an aqueous medium (can be rendered aqueous): (i) a monomer that is soluble in water and forms no micelles in water; and (ii) a monomer that is capable of forming micelles in water.

By adding the structural units, it is possible, when the polysiloxane-based resin is rendered aqueous in an aqueous medium, to obtain a solution or dispersion slurry having a level of viscosity appropriate as water-based paint.

There has been no report of a polysiloxane-based resin that achieves both (i) and (ii): (i) that the polysiloxane-based resin can be stably dispersed or dissolved in an aqueous medium (can be rendered aqueous) and (ii) that a solution or dispersion slurry having an appropriate level of viscosity can be obtained from the polysiloxane-based resin. Thus, the polysiloxane-based resin in accordance with one or more embodiments of the present invention is extremely useful as a material for paint, particularly water-based paint.

(2. Polysiloxane-Based Resin)

The polysiloxane-based resin in accordance with one or more embodiments of the present invention contains a polymer containing, as a structural unit, a structural unit derived from a monomer having a radically polymerizable group, the monomer including (i) a monomer that is soluble in water and forms no micelles in water and (ii) a monomer that is capable of forming micelles in water. In the present specification, a “polysiloxane-based resin in accordance with one or more embodiments of the present invention” may be simply referred to as “the present polysiloxane-based resin”.

Due to having the above-described configuration, the present polysiloxane-based resin makes it possible to provide a polysiloxane-based resin that can be stably dispersed or dissolved in an aqueous medium (can be rendered aqueous) and, when rendered aqueous, has an appropriate level of viscosity.

In the present disclosure, “polysiloxane-based resin” means a resin that contains a polysiloxane structure as a main component. The polysiloxane-based resin is not limited to any particular one, provided that it falls under the above definition. Examples of the polysiloxane-based resin include a resin containing, as a main component, a polysiloxane structure obtained through dehydrogenation condensation of a single compound represented by formula (I) below or through co-condensation of a plurality of compounds represented by formula (I) below:

R¹ₐR²_{b}—Si—(OR³)_{4-a-b} (I)

(where: R¹ is a substituted alkyl group having a polymerizable unsaturated group and 1 to 10 carbon atoms, an alkenyl group, or an aryl group that has a polymerizable unsaturated group and can optionally have other substituent(s); each R² is independently an unsubstituted or substituted alkyl group having 1 to 10 carbon atoms or an unsubstituted or substituted aryl group; each R³ is independently a hydrogen atom or an alkyl group having 1 to 10 carbon atoms; a is an integer of 1 to 3; b is an integer of 0 to 2; and a+b is an integer of 1 to 3).

Further, in one or more embodiments of the present invention, the polysiloxane-based resin can be a resin containing, as a main component, a polysiloxane structure obtained through co-condensation of (i) a single compound represented by formula (I) above or a plurality of compounds represented by formula (I) above and (ii) a single compound represented by formula (II) below or a plurality of compounds represented by formula (II) below:

R⁴ₙ—Si—(OR⁵)₄₋ₙ (II)

(where: each R⁴ is independently an unsubstituted or substituted alkyl group having 1 to 10 carbon atoms or an unsubstituted or substituted aryl group, and in a case where there are a plurality of R⁴s, the plurality of R⁴s can be identical to or different from each other; each R⁵ is independently a hydrogen atom or an alkyl group having 1 to 10 carbon atoms; and n is an integer of 0 to 3).

In the present specification, a polysiloxane structure which is a main component of a polysiloxane-based resin, that is, a structural unit obtained through condensation of a monomer having a hydrolyzable silyl group may be referred to as “main chain”, and a structural unit that binds to the main chain through radical polymerization and consists of a monomer having a radically polymerizable group may be referred to as “side chain”.

Side chains of the present polysiloxane-based resin each consist of a polymer containing a structural unit derived from a monomer having a radically polymerizable group. The monomers constituting the side chains of the present polysiloxane-based resin are not limited to any particular ones, provided that they include (i) a monomer that is soluble in water and forms no micelles in water and (ii) a monomer that is capable of forming micelles in water. The side chains of the present polysiloxane-based resin can be constituted by nothing but the (i) monomer and the (ii) monomer, or can include a monomer(s) other than the monomer (i) and the monomer (ii). Among the monomers constituting the side chains in accordance with one or more embodiments of the present invention, the monomer(s) other than the (i) monomer and the (ii) monomer each may be a monomer having no hydrolyzable silyl group and can optionally include a monomer having a hydrolyzable silyl group. Thus, the present polysiloxane-based resin can be expressed as follows as a preferable example: a polysiloxane-based resin having a side chain consisting of a polymer containing, as a structural unit, a structural unit derived from a monomer having a radically polymerizable group, the polysiloxane-based resin containing a structural unit (b) and a structural unit (c) as structural units of such side chains, the structural unit (b) being derived from a monomer (B) that (has no polyoxyalkylene structure,) has a salt structure consisting of an acid and a base, a radically polymerizable group, and no hydrolyzable silyl group, is soluble in water, and forms no micelles in water, the structural unit (c) being derived from a monomer (C) that (has a polyoxyalkylene structure,) has a structure capable of forming micelles in water, a radically polymerizable group, and no hydrolyzable silyl group.

In one or more embodiments of the present invention, the present polysiloxane-based resin contains: a structural unit (a) derived from a silane compound (A) that has a polymerizable unsaturated group and a hydrolyzable silyl group; the structural unit (b) derived from the monomer (B) that has a salt structure consisting of an acid and a base, a radically polymerizable group, and no hydrolyzable silyl group, is soluble in water, and forms no micelles in water; and the structural unit (c) derived from the monomer (C) that has a polyoxyalkylene structure, a radically polymerizable group, and no hydrolyzable silyl group and is capable of forming micelles in water. In one or more embodiments of the present invention, the present polysiloxane-based resin may be configured such that the structural unit (a) forms a main chain, and the structural units (b) and (c) each form a side chain.

In one or more embodiments of the present invention, it is more preferable that the present polysiloxane-based resin optionally further contain, as a structural unit of the main chain, a structural unit (d) derived from a silane compound (D) represented by formula (II) below in addition to the (A) to (C):

R⁴ₙ—Si—(OR⁵)₄₋ₙ (II)

(where: each R⁴ is independently an unsubstituted or substituted alkyl group having 1 to 10 carbon atoms or an unsubstituted or substituted aryl group, and in a case where there are a plurality of R⁴s, the plurality of R⁴s can be identical to or different from each other; each R⁵ is independently a hydrogen atom or an alkyl group having 1 to 10 carbon atoms; and n is an integer of 0 to 3).

Note that, in the following description, the “structural unit (a) derived from the silane compound (A) that has a radically polymerizable unsaturated group and a hydrolyzable silyl group” will be referred to simply as “structural unit (a)”, the “structural unit (b) derived from the monomer (B) that has a salt structure consisting of an acid and a base, a radically polymerizable group, and no hydrolyzable silyl group, is soluble in water, and forms no micelles in water” will be referred to simply as “structural unit (b)”, the “structural unit (c) derived from the monomer (C) that has a polyoxyalkylene structure, a radically polymerizable group, and no hydrolyzable silyl group and is capable of forming micelles in water” will be referred to simply as “structural unit (c)”, the “structural unit (d) derived from the silane compound (D) that is represented by general formula (II)” will be referred to simply as “structural unit (d)”, and the “structural unit (e) derived from the monomer (E) that has a radically polymerizable group and is other than the (A), the (B), and the (C)” will be referred to simply as “structural unit (e)”. Further, in the following description, the “silane compound (A) that has a radically polymerizable unsaturated group and a hydrolyzable silyl group” will be referred to simply as “silane compound (A)” or “monomer (A)”, the “monomer (B) that has a salt structure consisting of an acid and a base, a radically polymerizable group, and no hydrolyzable silyl group, is soluble in water, and forms no micelles in water” will be referred to simply as “monomer (B)”, the “monomer (C) that has a polyoxyalkylene structure, a radically polymerizable group, and no hydrolyzable silyl group and is capable of forming micelles in water” will be referred to simply as “monomer (C)”, the “silane compound (D) that is represented by general formula (II)” will be referred to simply as “silane compound (D)” or “monomer (D), and the “monomer (E) that has a radically polymerizable group and is other than the (A), the (B), and the (C)” will be referred to simply as “monomer (E)”.

(Structural Unit (a))

The structural unit (a) is derived from the silane compound (A) that has a radically polymerizable unsaturated group and a hydrolyzable silyl group.

The silane compound (A), which has a radically polymerizable unsaturated group and a hydrolyzable silyl group, is a silane compound represented by formula (I) below and having a hydrolyzable silyl group:

R¹ₐR²_{b}—Si—(OR³)_{4-a-b} (I)

(where: R¹ is a substituted alkyl group having a polymerizable unsaturated group and 1 to 10 carbon atoms, an alkenyl group, or an aryl group that has a polymerizable unsaturated group and can optionally have other substituent(s); each R² is independently an unsubstituted or substituted alkyl group having 1 to 10 carbon atoms or an unsubstituted or substituted aryl group; each R³ is independently a hydrogen atom or an alkyl group having 1 to 10 carbon atoms; a is an integer of 1 to 3; b is an integer of 0 to 2; and a+b is an integer of 1 to 3).

R¹ in formula (I) is: a substituted alkyl group having a radically polymerizable unsaturated group and 1 to 10 carbon atoms; an alkenyl group; or an unsubstituted or substituted aryl group having a radically polymerizable unsaturated group. Examples of the radically polymerizable unsaturated group include (meth)acryloyl group.

Examples of the silane compound (A) in which R¹ is an alkyl group having a radically polymerizable unsaturated group include (meth)acryloxymethyltrimethoxysilane, (meth)acryloxymethylmethyldimethoxysilane, (meth)acryloxymethyldimethylmethoxysilane, (meth)acryloxymethyltriethyleoxysilane, (meth)acryloxymethylmethyldiethoxysilane, (meth)acryloxymethyldimethylethoxysilane, 2-(meth)acryloxyethyltrimethoxysilane, 2-(meth)acryloxyethyl methyldimethoxysilane, 2-(meth)acryloxyethyldimethylmethoxysilane, 2-(meth)acryloxyethyltriethoxysilane, 2-(meth)acryloxyethyl methyldiethoxysilane, 2-(meth)acryloxyethyldimethylethoxysilane, γ-(meth)acryloxypropyltrimethoxysilane, γ-(meth)acryloxypropylmethyldimethoxysilane, γ-(meth)acryloxypropyldimethylmethoxysilane, γ-(meth)acryloxypropyltriethoxysilane, γ-(meth)acryloxypropylmethyldiethoxysilane, γ-(meth)acryloxypropyldimethylethoxysilane, 4-(meth)acryloxybutyltrimethoxysilane, 4-(meth)acryloxybutylmethyldimethoxysilane, 4-(meth)acryloxybutyldimethylmethoxysilane, 4-(meth)acryloxybutyltriethoxysilane, 4-(meth)acryloxybutylmethyldiethoxysilane, 4-(meth)acryloxybutyldimethylethoxysilane, 5-(meth)acryloxypentyltrimethoxysilane, 5-(meth)acryloxypentylmethyldimethoxysilane, 5-(meth)acryloxypentyldimethylmethoxysilane, 5-(meth)acryloxypentyltriethoxysilane, 5-(meth)acryloxypentylmethyldiethoxysilane, 5-(meth)acryloxypentylmethylethoxysilane, 6-(meth)acryloxyhexyltrimethoxysilane, 6-(meth)acryloxyhexylmethyldimethoxysilane, 6-(meth)acryloxyhexyldimethylmethoxysilane, 6-(meth)acryloxyhexyltriethoxysilane, 6-(meth)acryloxyhexylmethyldiethoxysilane, and 6-(meth)acryloxyhexyldimethylethoxysilane.

Examples of the silane compound (A) in which R¹ is an alkenyl group include vinyltrimethoxysilane, vinylmethyldimethoxysilane, vinyldimethylmethoxysilane, vinyltriethoxysilane, vinylmethyldiethoxysilane, and vinyldimethylethoxysilane.

Examples of the silane compound (A) in which R¹ is an aryl group that has a polymerizable unsaturated group and can optionally have other substituent(s) include p-styryltrimethoxysilane, p-styrylmethyldimethoxysilane, p-styryldimethylmethoxysilane, p-styryltriethoxysilane, p-styrylmethyldiethoxysilane, and p-styryldimethylethoxysilane.

Among these, a (meth)acryloyl group-substituted alkyl group is preferable as R¹ in terms of thermal radical polymerization reactivity.

Each R² in formula (I) is independently an unsubstituted or substituted alkyl group having 1 to 10 carbon atoms or an unsubstituted or substituted aryl group.

Specific examples of the alkyl group in R² in formula (I) include a methyl group, an ethyl group, a propyl group, an isopropyl group, a butyl group, an isobutyl group, an amyl group, an isoamyl group, a hexyl group, a cyclohexyl group, a cyclohexylmethyl group, a cyclohexylethyl group, a heptyl group, an isoheptyl group, an n-octyl group, an isooctyl group, and a 2-ethylhexyl group.

Specific examples of the aryl group in R² in formula (I) include a phenyl group, a naphthyl group, and a benzyl group.

R² in formula (I) may be a methyl group in a case where a is 1 and b is 1.

R³ in formula (I) is a hydrogen atom or an alkyl group having 1 to 10 carbon atoms, and can be, for example, a methyl group, an ethyl group, a propyl group, an isopropyl group, a butyl group, an isobutyl group, a pentyl group, a hexyl group, an amyl group, an isoamyl group, a hexyl group, a cyclohexyl group, a cyclohexylmethyl group, a cyclohexylethyl group, a heptyl group, an isoheptyl group, an octyl group, an n-octyl group, an isooctyl group, a 2-ethylhexyl group, a nonyl group, a decyl group, or the like.

From the viewpoint of facilitating condensation between the silane compound (A) and the other silane compound having no radically polymerizable unsaturated group (silane compound (D)), the number of carbon atoms in the alkyl group in each of R² and R³ in formula (I) may be 1 to 3, or 1.

In one or more embodiments of the present invention, a content of the structural unit (a) may be, for example, not less than 1% by weight or not less than 2% by weight, relative to 100% by weight of a total amount of the polysiloxane-based resin. In a case where the content of the structural unit (a) is within the above range, the structural unit (a) can be sufficiently graft-polymerized with the structural unit (b) and/or the structural unit (c) in a direct or indirect manner, so that it is possible to obtain a polysiloxane resin that can be stably dispersed or dissolved in an aqueous medium (can be rendered aqueous) can be obtained. Further, an upper limit of the content of the structural unit (a) is not particularly limited provided that effects of one or more embodiments of the present invention are provided, but may be, for example, not more than 10% by weight, not more than 8% by weight, or not more than 5% by weight.

(Structural Unit (b))

The structural unit (b) is derived from the monomer (B) that has a salt structure consisting of an acid and a base, a radically polymerizable group, and no hydrolyzable silyl group, is soluble in water, and forms no micelles in water.

In the present disclosure, “salt structure” means a structure of a neutral salt obtained by neutralizing an acid and a base. Note that the acid subjected to the neutralization can be a strong acid or a weak acid. The base subjected to the neutralization can be a strong base or a weak base.

In one or more embodiments of the present invention, the salt structure can be, for example, a structure of a neutral salt between a strong acid and a strong base, a structure of a neutral salt between a strong acid and a weak base, a structure of a neutral salt between a weak acid and a strong base, or a structure of a neutral salt between a weak acid and a weak base. More specific examples of the salt structure include: sodium sulfonate, potassium sulfonate, calcium sulfonate, sodium nitrate, potassium nitrate, calcium nitrate, and the like (a structure of a neutral salt between a strong acid and a strong base); ammonium sulfonate, ammonium nitrate, and the like (a structure of a neutral salt between a strong acid and a weak base); sodium acetate, potassium acetate, calcium acetate, sodium phosphate, potassium phosphate, calcium phosphate, and the like (a structure of a neutral salt between a weak acid and a strong base); and ammonium acetate, ammonium phosphate, and the like (a structure of a neutral salt between a weak acid and a weak base). In one or more embodiments of the present invention, the salt structure may be sodium sulfonate.

In the present disclosure, “soluble in water” means that, in a case where an aqueous solution of 1 g of the monomer of interest in 10 g of water having a temperature of 25° C. is sufficiently stirred and left to stand still for 1 week under a condition of 25° C., visual observation of an appearance of the aqueous solution finds the aqueous solution transparent without a precipitate, a dispersion, separation of layers, or the like in the aqueous solution.

In one or more embodiments of the present invention, a content of the structural unit (b) may be, for example, not less than 1% by weight, not less than 2% by weight, or not less than 4% by weight, relative to 100% by weight of a total amount of the polysiloxane-based resin. The structural unit (b) that has a content within the above range brings about an effect of enabling the polysiloxane-based resin to be uniformly dispersed or dissolved in water. Further, an upper limit of the content of the structural unit (b) is not particularly limited provided that effects of one or more embodiments of the present invention are provided, but may be, for example, not more than 20% by weight, not more than 15% by weight, or not more than 10% by weight.

In the present disclosure, “stably dispersed or dissolved in an aqueous medium” means that no generation of a “precipitate” is observed when a solution containing a polysiloxane-based resin is evaluated by the following method: an aqueous solution of a polysiloxane-based resin produced by a method described in Examples is left to stand still for 1 week under the condition of 25° C. and subjected to visual observation to evaluate an appearance of the aqueous solution.

In other words, “stably dispersed or dissolved in an aqueous medium” means that evaluation of a solution containing a polysiloxane-based resin by the above method finds that the solution containing the polysiloxane-based resin is uniformly “colorless and transparent”, “bluish white and transparent”, or “white and dispersed”. A case in which a “precipitate” is observed does not fall under “stably dispersed or dissolved in an aqueous medium”.

The monomer (B) is a monomer that has a salt structure consisting of an acid and a base, a radically polymerizable group, and no hydrolyzable silyl group, is soluble in water, and forms no micelles in water. The radically polymerizable group in the monomer (B) undergoes radical polymerization with the radically polymerizable group in the monomer (A) to form, on the polysiloxane main chain, a graft chain derived from the monomer (B). Due to the fact that the monomer (B) has a salt structure consisting of an acid and a base and is soluble in water, the present polysiloxane-based resin can be stably dispersed or dissolved in an aqueous medium.

The radically polymerizable unsaturated group in the monomer (B) is not limited to any particular one, provided that it can contribute to radical polymerization with the monomer (A). Examples of the radically polymerizable unsaturated group in the monomer (B) include a (meth)acryloyl group, a (meth)acrylamide group, and a vinyl group. From the viewpoint of high reactivity and versatility, the (meth)acryloyl group or the (meth)acrylamide group is preferable.

The monomer (B) is not limited to any particular one, provided that it is a monomer having: a salt structure consisting of an acid and a base; and a radically polymerizable group. Examples of the monomer (B) include sodium sulfoethylmethacrylate, sodium acrylamide-t-butyl sulfonate, 2-(methacryloyloxy)sodium ethanesulfonate, sodium acrylamide-t-butyl sulfonate, 2-(methacryloyloxy) potassium ethanesulfonate, potassium acrylamide-t-butyl sulfonate, 2-(methacryloyloxy)calcium ethanesulfonate, calcium acrylamide-t-butyl sulfonate, ammonium sulfoethylmethacrylate, ammonium acrylamide-t-butyl sulfonate, 2-(methacryloyloxy)ammonium ethanesulfonate, ammonium acrylamide-t-butyl sulfonate, sodium acrylate, potassium acrylate, calcium acrylate, ammonium acrylate, sodium methacrylate, potassium methacrylate, calcium methacrylate, and ammonium methacrylate.

The monomer (B) can be obtained as a commercial product. Examples of the commercial product include “Antox MS-2N-D” manufactured by Nippon Nyukazai Co., Ltd., “ATBS-Na” manufactured by TOAGOSEI CO., LTD., and “sodium acrylate” and “potassium acrylate” manufactured by ASADA CHEMICAL INDUSTRY CO., LTD.

Whether or not the monomer is “capable of forming micelles in water” is determined by a method described in the (Structural unit (c)) section.

(Structural Unit (c))

The structural unit (c) is derived from the monomer (C) that has a radically polymerizable group and no hydrolyzable silyl group and is capable of forming micelles in water. The radically polymerizable group in the monomer (C) undergoes radical polymerization directly or indirectly with the radically polymerizable group in the monomer (A) to form, on the polysiloxane main chain, a graft chain derived from the monomer (C). Due to containing the structural unit (c), the present polysiloxane-based resin forms micelles when rendered aqueous. This allows the present polysiloxane-based resin to have an appropriate level of viscosity and thus be used in water-based paint and the like.

In the present disclosure, a “micelle” means an assembly formed by association of amphipathic molecules through a hydrophobic interaction. Note that an amphipathic molecule means a molecule having a hydrophobic group and a hydrophilic group in the molecule. Thus, a “structure capable of forming micelles in water” means a structure that has a hydrophobic group and a hydrophilic group in a molecule.

In one or more embodiments of the present invention, the monomer (C) can be an amphipathic molecule that has no hydrolyzable silyl group.

Whether or not a monomer is “capable of forming micelles in water” is determined by the following method. To two layers of liquid including 10 g of water and 2 g of butyl acetate, 1 g of the monomer of interest is added and stirred sufficiently. Then, in a case where a uniform white turbidity is observed after the resultant mixture is left to stand still for 12 hours, the monomer of interest is determined to be capable of forming micelles in water. In a case where transparent layers of water and butyl acetate separate from each other are observed after the mixture is left to stand still for 12 hours, the monomer of interest is determined to not form micelles (to be incapable of forming micelles) in water.

In the present disclosure, to “have an appropriate level of viscosity” means that measurement of a viscosity of a solution containing a polysiloxane-based resin finds that the viscosity of the solution is not more than 7,000 mPa-S. The viscosity may be not more than 6,000 mPa-S, not more than 5,000 mPa-S, or not more than 4,000 mPa-S. Note that the viscosity of the solution containing the polysiloxane-based resin is measured by a method described in Examples.

The monomer (C) is not limited to any particular one, provided that it is a monomer having: a radically polymerizable group; a structure that forms micelles in water (i.e., a structure in which a hydrophobic group and a hydrophilic group are present in a molecule); and no hydrolyzable silyl group.

The hydrophobic group in the monomer (C) is not limited to any particular one, and can be, for example, an alkyl group having a radically polymerizable group and not less than 3 carbon atoms, an aryl group, or the like.

The hydrophilic group in the monomer (C) is not limited to any particular one. Examples of the hydrophilic group in the monomer (C) include: an anionic hydrophilic group such as sulfonate, carboxylate, and a sulfate ester salt; a cationic hydrophilic group such as an amine salt and a quaternary ammonium salt; an amphoteric hydrophilic group such as betaine; and a nonionic hydrophilic group such as polyoxyalkylene.

In one or more embodiments of the present invention, the monomer (C) may have a polyoxyalkylene structure from the viewpoint of versatility. Examples of such a monomer include polyoxyethylene and polyoxypropylene. The monomer (C) may have a polyoxyalkylene structure having 1 to 100 oxyalkylene repeating units, a polyoxyalkylene structure having 2 to 50 oxyalkylene repeating units, or a polyoxyalkylene structure having 5 to 20 oxyalkylene repeating units.

The monomer (C) is not limited to any particular one, provided that it falls under the above definition. Examples of the monomer (C) include ADEKA REASOAP SR-05, SR-10, SR-20, SR-1025, SR-2025, SR-3025, SR-10S, NE-10, NE-20, NE-30, NE-40, SE-10, SE-20, ER-10, ER-20, ER-30, and ER-40 manufactured by ADEKA CORPORATION, Antox-MS-60, RMA-1120, RMA-564, RMA-568, RMA-506, MA-30, MA-50, MA-100, MA-150, RMA-1120, MPG130-MA, MPG-130MA, RMA-150M, RMA-300M, RMA-450M, RA-1020, and RA-1820 manufactured by Nippon Nyukazai Co., Ltd., Aqualon KH-05, KH-10, RN-20, RN-30, RN-50, RN-2025, HS-10, HS-20, HS-1025, BC05, BC10, BC0515, BC 1025 manufactured by DKS Co. Ltd., ELEMINOL JS-2, JS-20, and RS-30 manufactured by Sanyo Chemical Industries, Ltd., LATEMUL S-180, S-180A, PD-104, PD-420, and PD-430 manufactured by Kao Corporation, BLEMMER PE-90, PE-200, PE-350, AE-90, AE-200, AE-350, PP-500, PP-800, PP-1000, AP-400, AP-550, AP-800, 700PEP-350B, 10PEP-550B, 55PET-400, 30PET-800, 55PET-800, 30PPT-800, 50PPT-800, 70PPT-800, PME-100, PME-200, PME-400, PME-1000, PME-4000, AME-400, 50POEP-800B, 50AOEP-800B, AEP, AET, APT, PLE, ALE, PSE, ASE, PKE, AKE, PNE, ANE, PNP, ANP, and PNEP-600 manufactured by NOF CORPORATION, Light Ester 130MA, 041MA, MTG, Light Acrylate EC-A, MTG-A, 130A, DPM-A, P-200A, NP-4EA, NP-8EA, and EHDG-A manufactured by Kyoeisha Chemical Co., Ltd., and NK-ESTER M-20G, M-40G, M-90G, M-230G, AMP-10G, AMP-20G, AMP-60G, AM-90G, and LA manufactured by SHIN-NAKAMURA CHEMICAL Co., Ltd. From the viewpoint of versatility and micellar stability, ADEKA REASOAP SR-10 is preferable.

In one or more embodiments of the present invention, the monomer (C) can have a salt structure consisting of an acid and a base. The salt structure can be, for example, a structure of a neutral salt between a strong acid and a strong base, a structure of a neutral salt between a strong acid and a weak base, a structure of a neutral salt between a weak acid and a strong base, or a structure of a neutral salt between a weak acid and a weak base. More specific examples of the salt structure include: sodium sulfonate, potassium sulfonate, calcium sulfonate, sodium nitrate, potassium nitrate, calcium nitrate, and the like (a structure of a neutral salt between a strong acid and a strong base); ammonium sulfonate, ammonium nitrate, and the like (a structure of a neutral salt between a strong acid and a weak base); sodium acetate, potassium acetate, calcium acetate, sodium phosphate, potassium phosphate, calcium phosphate, and the like (a structure of a neutral salt between a weak acid and a strong base); and ammonium acetate, ammonium phosphate, and the like (a structure of a neutral salt between a weak acid and a weak base). In one or more embodiments of the present invention, the salt structure may be sodium sulfonate or ammonium sulfonate.

In one or more embodiments of the present invention, a content of the structural unit (c) may be, for example, not less than 0.5% by weight, not less than 1% by weight, or not less than 2% by weight, relative to 100% by weight of a total amount of the polysiloxane-based resin. The structural unit (c) that has a content within the above range brings about an effect of making it possible to obtain a solution having an appropriate level of viscosity when the polysiloxane-based resin is made into the solution with use of an aqueous medium. Further, an upper limit of the content of the structural unit (c) may be, for example, not more than 15% by weight, not more than 10% by weight, or not more than 8% by weight. In a case where the content of the structural unit (c) is within the above range, the obtained cured product has a good water resistance.

In the present polysiloxane-based resin, a ratio (monomer (B)/monomer (C)) of a content of the monomer (B) to a content of the monomer (C) relative to 100% by weight of a total amount of the polysiloxane-based resin may be 1/4 to 5/1, 1/4 to 4/1, 1/3 to 3/1, 1/2 to 2/1, or 1/1.5 to 1.5/1. In a case where the ratio of the content of the monomer (B) to the content of the monomer (C) is within the above range, it is possible to provide a polysiloxane-based resin that can be stably dispersed or dissolved in an aqueous medium and, when made into a solution, has an appropriate level of viscosity.

(Structural Unit (d))

The structural unit (d) is a structural unit derived from the silane compound (D) represented by formula (II) below: R⁴ₙ—Si—(OR⁵)₄₋ₙ . . . (II) The silane compound (D) is a silane compound represented by formula (II) below and having a hydrolyzable silyl group: R⁴ₙ—Si—(OR⁵)₄₋ₙ . . . (II) (where: each R⁴ is independently an unsubstituted or substituted alkyl group having 1 to 10 carbon atoms or an unsubstituted or substituted aryl group, and in a case where there are a plurality of R⁴s, the plurality of R⁴s can be identical to or different from each other; each R⁵ is independently a hydrogen atom or an alkyl group having 1 to 10 carbon atoms; and n is an integer of 0 to 3). The silane compound (D) undergoes dehydrogenation condensation with the silane compound (A) and/or the silane compound (D) to form polysiloxane. It can be said that the silane compound (D) is a silane compound having no radically polymerizable unsaturated group and having a hydrolyzable silyl group. In the present specification, the silane compound (D) may be referred to as a monomer (D). The structural unit (d) can be constituted only by one silane compound (D) represented by formula (II) or by a combination of two or more silane compounds (D).

Specific examples of the alkyl group in R⁴ in formula (II) include a methyl group, an ethyl group, a propyl group, an isopropyl group, a butyl group, an isobutyl group, an amyl group, an isoamyl group, a hexyl group, a cyclohexyl group, a cyclohexylmethyl group, a cyclohexylethyl group, a heptyl group, an isoheptyl group, an n-octyl group, an isooctyl group, and a 2-ethylhexyl group.

Specific examples of the aryl group in R⁴ in formula (II) include a phenyl group, a naphthyl group, and a benzyl group.

R⁵ in formula (II) is a hydrogen atom or an alkyl group having 1 to 10 carbon atoms and can be, for example, a methyl group, an ethyl group, a propyl group, a butyl group, a pentyl group, a hexyl group, an octyl group, a nonyl group, a decyl group, or the like.

Specific examples of the compound represented by formula (II) include tetramethoxysilane, tetraethoxysilane, tetraisopropoxysilane, methyltrimethoxysilane, methyltriethoxysilane, methyltriisopropoxysilane, ethyltrimethoxysilane, ethyltriethoxysilane, ethyltriisopropoxysilane, propyltrimethoxysilane, propyltriethoxysilane, propyltriisopropoxysilane, butyltrimethoxysilane, butyltriethoxysilane, butyltriisopropoxysilane, hexyltrimethoxysilane, hexyltriethoxysilane, hexyltriisopropoxysilane, octyltrimethoxysilane, octyltriethoxysilane, octyltriisopropoxysilane, phenyltrimethoxysilane, phenyltriethoxysilane, phenyltriisopropoxysilane, dimethyldimethoxysilane, methylphenyldimethoxysilane, diphenyldimethoxysilane, trimethylmonomethoxysilane, and triphenylmonomethoxysilane.

n in formula (II) only needs to be an integer of 0 to 3, but a trialkoxysilane compound in which n is 1 is particularly preferable. In a case where n is 1, there are three crosslinkable hydrolyzable silyl groups, so that a polymer having a network structure can be formed and thus an obtained polysiloxane-based resin is expected to have an improved durability and an improved weather resistance. Specific examples of the compound represented by formula (II) where n is 1 include methyltrimethoxysilane and phenyltrimethoxysilane from the viewpoint of availability.

From the viewpoint of facilitating condensation between the silane compound (D) and the silane compound (A) and/or the silane compound (D), the number of carbon atoms in the alkyl group in R⁵ in formula (II) may be 1 to 3, or 1.

In one or more embodiments of the present invention, a content of the structural unit (d) may be, for example, not less than 15% by weight, not less than 25% by weight, or not less than 35% by weight, relative to 100% by weight of a total amount of the polysiloxane-based resin. The structural unit (d) that has a content of not less than 15% by weight brings about an effect of exhibiting high weather resistance, toughness, low tackiness, and the like. Further, an upper limit of the content of the structural unit (d) is not particularly limited provided that effects of one or more embodiments of the present invention are provided, but is, for example, not more than 80% by weight.

In one or more embodiments of the present invention, in a case where the present polysiloxane-based resin contains the structural unit (d), a total content of the structural units (a) and (d) may be, for example, not less than 10% by weight, not less than 20% by weight, or not less than 40% by weight, relative to 100% by weight of a total amount of the polysiloxane-based resin. The structural units (a) and (d) that together have a total content of not less than 10% by weight brings about an effect of enabling the present polysiloxane-based resin to have excellent weather resistance, toughness, tackiness, and the like. Further, an upper limit of the total content of the structural units (a) and (d) is not particularly limited provided that effects of one or more embodiments of the present invention are provided, but is, for example, not more than 90% by weight.

(Structural Unit (e))

The structural unit (e) is derived from a monomer (E) that has a radically polymerizable unsaturated group and is other than the (A), the (B), and the (C). The monomer (E) from which the structural unit (e) is derived binds directly or indirectly to the monomer (A) and/or the monomer (B) and/or the monomer (C) through radical polymerization, and binds to the structural unit (a) and/or the structural unit (b) and/or the structural unit (c).

The monomer (E) from which the structural unit (e) is derived is not limited to any particular one, provided that it is a monomer that has a radically polymerizable unsaturated group and is other than the (A), the (B), and the (C). Examples of the monomer (E) from which the structural unit (e) include an alkyl (meth)acrylate ester and a monomer other than a (meth)acrylic acid alkyl ester as described below.

<(Meth)Acrylic Acid Alkyl Ester>

In one or more embodiments of the present invention, the (meth)acrylic acid alkyl ester is a (meth)acrylic acid ester having an alkyl group having 1 to 18 carbon atoms, and can be a (meth)alkyl monomer that does not contain a functional group such as a hydroxyl group or an epoxy group. In one or more embodiments of the present invention, the alkyl group in the (meth)acrylic acid alkyl ester can be linear or branched, and can be a cyclic cycloalkyl group. Specific examples of the above include methyl(meth)acrylate, ethyl(meth)acrylate, n-butyl(meth)acrylate, iso-butyl(meth)acrylate, tert-butyl(meth)acrylate, benzyl(meth)acrylate, cyclohexyl(meth)acrylate, 2-ethylhexyl(meth)acrylate, isodecyl(meth)methacrylate, lauryl(meth)acrylate, tridecyl(meth)acrylate, stearyl(meth)acrylate, and isobonyl(meth)acrylate.

<Monomer Other than (Meth)Acrylic Acid Alkyl Ester>

Examples of the monomer other than a (meth)acrylic acid alkyl ester include: a nitrile group-containing radically polymerizable monomer such as (meth)acrylonitrile; a hydroxyl group-containing radically polymerizable monomer such as glycidyl(meth)acrylate; 2-hydroxypropyl(meth)acrylate; 2-hydroxypropyl(meth)acrylate; a monomer having two or more polymerizable, unsaturated bonds such as ethylene glycol di(meth)acrylate and allyl(meth)acrylate; and a fluorine-containing radically polymerizable monomer such as trifluoro(meth)acrylate, pentafluoro(meth)acrylate, perfluorocyclohexyl (meth)acrylate, 2,2,3,3-tetrafluoropropylmethacrylate, and B3-(perfluorooctyl)ethyl(meth)acrylate.

In one or more embodiments of the present invention, a content of the structural unit (e) may be, for example, not less than 10% by weight, not less than 20% by weight, or not less than 30% by weight, relative to 100% by weight of a total amount of the polysiloxane-based resin. The structural unit (e) that has a content within the above range brings about an effect of imparting elasticity to the coating film. Further, an upper limit of the content of the structural unit (e) is not particularly limited provided that effects of one or more embodiments of the present invention are provided, but may be, for example, not more than 90% by weight, not more than 80% by weight, or not more than 70% by weight.

Further, the present polysiloxane-based resin may have a weight average molecular weight of, for example, 1,000 to 1,000,000, 3,000 to 500,000, or 4,000 to 100,000. The main chain of the present polysiloxane-based resin may have a weight average molecular weight of 100 to 500,000, 500 to 100,000, or 1000 to 50,000. The present polysiloxane-based resin that has a weight average molecular weight within the above range brings about an effect of exhibiting weather resistance and durability while exhibiting viscosity.

In one or more embodiments of the present invention, a ratio of the polysiloxane structure (the structural unit (a), or the structural units (a) and (d)), which is the main chain in the present polysiloxane-based resin, and a graft chain (the structural unit(s) (b), (c), and/or (e)), which is a side chain in the present polysiloxane-based resin, may be, for example, 20:80 to 80 to 20, 30:70 to 75:25, or 35:65 to 70:30. An upper limit of the ratio may be not more than 85:15 from the viewpoint of storage stability. A lower limit of the ratio may be not less than 30:70 from the viewpoint of water resistance, weather resistance, low tackiness, and the like.

Note that a ratio of each structural unit contained in the present polysiloxane-based resin (a weight ratio (% by weight) of the structural unit relative to 100% by weight of the total amount of the polysiloxane-based resin) is in proportion to an amount obtained by subtracting, from an amount of each monomer contained in the present polysiloxane-based resin, a structure that is separated through a dehydration condensation reaction and the like. That is, the amount (% by weight) of each structural unit relative to 100% by weight of the total amount of the present polysiloxane-based resin can be said to be an amount obtained by taking account of a reduction in weight during synthesis of the polysiloxane-based resin from an amount of the added monomer constituting the each structural unit.

In one or more embodiments of the present invention, the present polysiloxane-based resin has a weight average molecular weight that is not particularly limited but may be, for example, 5,000 to 500,000, 8,000 to 100,000, or 10,000 to 80,000. Note that measurement of the weight average molecular weight of the present polysiloxane-based resin is carried out with use of a high-speed GPC device HLC-8320GPC manufactured by TOSOH CORPORATION.

[3. Resin Composition]

A resin composition in accordance with one or more embodiments of the present invention (hereinafter referred to as “the present resin composition”) is a resin composition that contains the polysiloxane-based resin described above in [2. Polysiloxane-based resin]. The present polysiloxane-based resin contained in the present resin composition makes it possible to provide a polysiloxane-based resin that can be stably dispersed or dissolved in an aqueous medium and, when rendered aqueous, has an appropriate level of viscosity. The present polysiloxane-based resin is therefore particularly useful in applications to water-based paint. Further, because the present polysiloxane-based resin has the above properties, the present resin composition may be an aqueous medium.

The present resin composition may contain water and a nonaqueous solvent, for example, in an amount of not less than 30% by weight and in an amount of not more than 10% by weight, respectively, in an amount of not less than 35% by weight and in an amount of not more than 5% by weight, respectively, or in an amount of not less than 37% by weight and in an amount of not more than 3% by weight, respectively, relative to an amount of the polysiloxane-based resin described above in [2. Polysiloxane-based resin].

In the present disclosure, a “nonaqueous solvent” means any solvent other than water. The “nonaqueous solvent” in the present specification can be a water-containing mixed solvent, examples of which include a solvent containing less than 50% by weight of water. The nonaqueous solvent is not limited to any particular one, provided that the above definition is met. Examples of the nonaqueous solvent include: a hydrocarbon such as toluene, xylene, n-hexane, and cyclohexane; an acetate ester such as ethyl acetate and butyl acetate; a cellosolve such as ethylcellosolve and butyl cellosolve; an ether ester such as cellosolve acetate; a ketone such as methyl ethyl ketone, ethyl acetoacetate, acetylacetone, methyl isobutyl ketone, and acetone; an alcohol such as methanol, 2-propanol, n-butanol, isobutanol, hexanol, and octanol.

The present resin composition can contain a curing catalyst as well as the polysiloxane-based resin described above in [2. Polysiloxane-based resin]. Addition of the curing catalyst that facilitates a hydrolytic condensation reaction of a hydrolyzable silyl group facilitates a crosslinking reaction when the present resin composition is applied as paint.

Examples of the curing catalyst is not limited to any particular one, but can be, for example, an organometallic compound, a basic catalyst, or the like. In particular, an organic tin compound and an amine compound are preferable from the viewpoint of activity.

Examples of the organometallic compound include an organotin compound and an organic titanium compound. In particular, an organotin compound is preferable for making it less likely for the cured film to undergo coloring.

Examples of the organotin compound include dibutyltin dilaurate, dibutyltin dimalate, dibutyltin dioleyl malate, dioctyltin dilaurate, dibutyltin diacetate, dibutyltin dimethoxide, dibutyltin thioglycolate, dibutyltin bisisononyl 3-mercaptopropionate, dibutyltin bisisooctylthioglycolate, dibutyltin bis2-ethylhexylthioglycolate, dimethyltin bisdodecylmercaptide, dimethyltin bis(octylthioglycolate ester) salt, and tin octylate.

In particular, from the viewpoint of stability in water, the organotin compound may be a mercaptide-based compound such as dibutyltin thioglycolate, dibutyltin bisisononyl 3-mercaptopropionate, dibutyltin bisisooctylthioglycolate, dibutyltin bis2-ethylhexylthioglycolate, dimethyltin bisdodecylmercaptide, dibutyltin bisdodecylmercaptide, and dimethyltin bis(octylthioglycolate ester) salt.

Examples of the basic catalyst include an inorganic basic compound and an amine compound. In particular, the amine compound can be suitably used.

Examples of the amine compound include triethylamine, n-butylamine, hexylamine, triethanolamine, diazabicycloundecene, and ammonia.

(Additive)

The present resin composition can contain an additive ordinarily used in this technical field (in particular, the field of paint), provided that effects of one or more embodiments of the present invention are exhibited. Examples of the additive include a pigment, a filler, a plasticizer, a film foaming aid, a wetting agent, a dispersing agent, a thickener, a defoaming agent, a preservative, an antioxidant, an anti-settling agent, a leveling agent, an ultraviolet ray absorbing agent, an antistatic agent, an antifreezing agent, an antimicrobial agent, an anti-fungal and anti-algae agent, a tackifier, an anti-rust agent, and a hydrophilization agent. These additives can be contained alone, or two or more of these additives can be contained in combination. A content of each of these additives can be set as appropriate by a person skilled in the art according to the purpose of using the additive.

More specific examples of the defoaming agent that can be contained in the present resin composition include a silicone-based defoaming agent, a surfactant-based defoaming agent, a polyether-based defoaming agent, a higher alcohol-based defoaming agent, and an acrylic-based defoaming agent. In particular, the silicone-based defoaming agent is preferable due to its advantage of being superior in defoaming property.

More specific examples of the hydrophilization agent that can be contained in the present resin composition include silicate and a surfactant. In particular, silicate is preferable due to its advantage of being able to provide a cured film that is excellent in weather resistance and durability.

[4. Aqueous Solution, Water-Based Paint, and Cured Film]

In one or more embodiments of the present invention, provided is a solution or dispersion slurry (hereinafter also referred to as “the present solution or the present dispersion slurry”) containing the present resin composition and also containing water as a medium. In the present disclosure, the “solution containing water as a medium” means a liquid that has a transparent appearance at a resin solid content concentration of 20% and a ratio of water of not less than 90% by weight in the entire medium. More specifically, the “solution containing water as a medium” means a liquid that has a haze value of not more than 20.0 at a pressure of 1 atmosphere and 25° C. In the present disclosure, the “dispersion slurry containing water as a medium” means a liquid that looks white and turbid at a resin solid content concentration of 20% and a ratio of water of not less than 90% by weight in the entire medium. More specifically, the “dispersion slurry containing water as a medium” means a liquid that has a haze value of more than 20.0 at a pressure of 1 atmosphere and 25° C. Note that measurement of the haze value is carried out with use of COH400 manufactured by NIPPON DENSHOKU INDUSTRIES CO., LTD., taking pure water as a standard solution.

The present solution or the present dispersion slurry contains the present resin composition described above, and thus can be stably dispersed or dissolved in a solution containing water as a medium and, when used as water-based paint, has an appropriate level of viscosity. The present solution or the present dispersion slurry is thus useful.

In one or more embodiments of the present invention, provided is water-based paint (hereinafter also referred to as “the present water-based paint”) containing the present resin composition, the present solution, or the present dispersion slurry. Due to containing the present aqueous solution or the present dispersion slurry described above, the present water-based paint can be stably dispersed or dissolved in a solution containing water as a medium and also has an appropriate level of viscosity. The present water-based paint is therefore useful.

The present water-based paint can contain, in addition to the present aqueous solution or the present dispersion slurry described above, an additive ordinarily used in this technical field (in particular, the field of paint). For the additive that can be contained in the present water-based paint, the description in the (Additive) section in the above (3. Resin composition) section will be incorporated as appropriate.

The present water-based paint may contain a defoaming agent from the viewpoint of improving the appearance of the obtained cured film. More specific examples of the defoaming agent that can be contained in the present water-based paint include a silicone-based defoaming agent, a surfactant-based defoaming agent, a polyether-based defoaming agent, a higher alcohol-based defoaming agent, and an acrylic-based defoaming agent. In particular, a silicone-based defoaming agent is preferable as it makes it possible to obtain a cured film excellent in defoaming property and more excellent in appearance.

The present water-based paint may contain a hydrophilization agent because containing the hydrophilization agent has the advantage of making it possible to improve the weather resistance, durability, and the like of the obtained cured film and thus to provide a cured film that has a high antifouling property (is stain-resistant). More specific examples of the hydrophilization agent that can be contained in the present water-based paint include silicate and a surfactant. In particular, silicate is preferable because it enables the obtained cured film to have further improved weather resistance and durability and an even better antifouling property.

Further, in one or more embodiments of the present invention, provided is a cured film obtained by curing the present resin composition or applying the present solution, the present dispersion slurry, or the present water-based paint. The curing method used in producing the cured film can be any known method. The cured film in accordance with one or more embodiments of the present invention can be said to be a cured film that is obtained by curing the present resin composition or by applying and curing the present solution, the present dispersion slurry, or the present water-based paint.

The method of applying the present solution, the present dispersion slurry, or the present water-based paint is not particularly limited. The present solution, the present dispersion slurry, or the present water-based paint can be applied, for example, with use of a brush, a roller, an air spray, an airless spray, or the like used in general painting, or by reverse coating, gravure coating, bar coating, die coating, spray coating, kiss coating, wire bar coating, curtain coating, or the like.

The present solution, the present dispersion slurry, or the present water-based paint may be applied directly on a base material. However, due to some advantages such as further improving adhesion to the base material, it is preferable that an undercoat layer be formed by applying an undercoat on the base material in advance and the present solution, the present dispersion slurry, or the present water-based paint be applied onto the undercoat layer. In other words, it is preferable to apply the present solution, the present dispersion slurry, or the present water-based paint onto the base material with the undercoat interposed therebetween.

The base material onto which the present solution, the present dispersion slurry, or the present water-based paint (or the undercoat) is applied is not limited to any particular one, and can be an organic base material or an inorganic base material.

The cured film in accordance with one or more embodiments of the present invention may be a cured film obtained by applying the present solution, the present dispersion slurry, or the present water-based paint onto an undercoat layer. That is, in one or more embodiments of the present invention, provided is a laminate in which the undercoat layer and the present cured film are stacked in this order. It can be said that the laminate in accordance with one or more embodiments of the present invention is a laminate obtained by stacking the undercoat layer and the present cured film in this order on the base material.

Examples of the undercoat forming the undercoat layer include a primer, a sealer, and a filler.

The primer is not limited to any particular one, and it is possible to use a variety of primers ordinarily used in the field of paints. For example, any of oil-based, water-based, or antirust primers can be used. Specific examples of the primer include an epoxy-based primer, a urethane-based primer, a silicon-based primer, and a zinc-rich primer.

The sealer is not limited to any particular one, and it is possible to use a variety of sealers ordinarily used in the field of paints. For example, any of oil-based, water-based, or antirust sealers can be used. Specific examples of the sealer include an epoxy-based sealer, a urethane-based sealer, a silicon-based sealer, and a zinc-rich sealer.

[5. Method for Producing Polysiloxane-Based Resin]

A “method for producing a polysiloxane-based resin in accordance with one or more embodiments of the present invention (hereinafter referred to as “the present production method”) includes a step of carrying out dehydrogenation condensation and radical polymerization of the monomer (A), the monomer (B), and the monomer (C). In one or more embodiments of the present invention, the dehydrogenation condensation and the radical polymerization can be carried out individually or simultaneously. In one or more embodiments of the present invention, the present production method can be further configured such that, in addition to the (A) to (C), the monomer (D) and/or the monomer (E) can be optionally reacted, individually or simultaneously.

In the present production method, examples of a method of simultaneously carrying out dehydrogenation condensation and radical polymerization of the monomers include a method that includes (Step 1) and (Step 2) below. Note that the present production method is not limited to the above.

(Step 1)

In Step 1, dehydrogenation condensation of a mixture is carried out in a reaction container, the mixture containing: the monomer (A) or the monomers (A) and (D) (hereinafter the “monomer (A)” and the “monomers (A) and (D)” may be collectively referred to as a “silane compound for dehydrogenation condensation”); water; and, as needed, a dehydrogenation condensation catalyst. Step 1 can be said to be a step of obtaining a co-condensation product of the silane compound for dehydrogenation condensation.

(Step 2)

In Step 2, after the entire mixture comes to have a weight average molecular weight within a specific range in Step 1, the monomer (B), the monomer (C), the radical polymerization initiator, and, as needed, the monomer (E) are added to the reaction container in succession, and at least radical polymerization is carried out. In Step 2, dehydrogenation condensation between hydrolyzable silyl groups derived from the silane compound for dehydrogenation condensation may occur simultaneously with the radical polymerization.

In one or more embodiments of the present invention, the number of moles of the water added in Step 1 may be, for example, not less than 0.25 times, or not less than 0.5 times, the total number of moles of the silane compound for dehydrogenation condensation. In a case where the number of moles of the water is not less than 0.25 times the total number of moles of the silane compound for dehydrogenation condensation, the condensation can be carried out properly, and sufficient water resistance, weather resistance, and low tackiness can be expected. There is no particular upper limit to the number of moles of the water, but from the viewpoint of production costs, the number may be limited to not more than 4.0 times the total number of moles of the silane compound for dehydrogenation condensation. In light of these viewpoints, the number of moles of the water may be 0.25 times to 4.0 times the total number of moles of the silane compound for dehydrogenation condensation, 0.5 times to 3.0 times the total number of moles of the silane compound for dehydrogenation condensation, or 1.0 times to 2.5 times the total number of moles of the silane compound for dehydrogenation condensation.

In Step 1, a silanol group which is generated through hydrolysis of hydrolyzable silyl group triggers a reduction in storage stability of the obtained co-condensation product and the obtained polysiloxane-based resin because the silanol group causes dehydration condensation between the silanol group and another silanol group and/or dealcoholization condensation between the silanol group and another hydrolyzable silyl group. Meanwhile, the silanol group solvates with a hydrophilic solvent such as alcohol. Thus, the silanol group whose amount is not less than a certain amount also brings about an effect of enhancing storage stability of the obtained co-condensation product and the resultant polysiloxane-based resin. Moreover, the co-condensation product which is concentrated in the reduced-pressure distillation step easily gelates. This may make it impossible for the co-condensation product to be concentrated to such an extent as to have a high concentration. From this viewpoint, water may be added in an amount of not more than 2.0 times the total number of moles of the monomer (A) and the monomer (D).

In one or more embodiments of the present invention, an amount of the monomer (A) at the time of condensation between the monomer (A) and the monomer (D) may be, for example, 1% by weight to 10% by weight, 2% by weight to 8% by weight, or 3% by weight to 6% by weight, relative to a total weight of the monomer (A) and the monomer (D). The monomer (A) that has an amount within the above range can be sufficiently graft-polymerized with the monomer (B) and the monomer (C) and thus brings about an effect of: enabling the polysiloxane-based resin to be uniformly dispersed or dissolved in water; and making it possible to make the polysiloxane-based resin into a solution that has an appropriate level of viscosity.

The dehydrogenation condensation catalyst in Step 1 is not limited to any particular one, provided that it is a substance that can facilitate the dehydrogenation condensation reaction of the mixture containing the silane compound for dehydrogenation condensation and the water.

In one or more embodiments of the present invention, examples of the dehydrogenation condensation catalyst include an acidic catalyst and a basic catalyst.

The acidic catalyst may be an organic acid in terms of compatibility with the silane compound for dehydrogenation condensation and the diluent solvent, and phosphate esters and carboxylic acids can be suitably used. Specific examples of the organic acid include ethyl acid phosphate, butyl acid phosphate, dibutylpyrophosphate, butoxyethyl acid phosphate, 2-ethylhexyl acid phosphate, isotridecyl acid phosphate, dibutyl phosphate, bis(2-ethylhexyl)phosphate, formic acid, acetic acid, butyric acid, and isobutyric acid.

The basic catalyst may be an organic base catalyst, in terms of compatibility of the organic base catalyst with the silane compound for dehydrogenation condensation and the diluent solvent, and amine compounds can be suitably used. Specific examples of the organic base include triethylamine, diazabicycloundecene, and 1,4-diazabicyclo[2.2.2]octane.

The above examples of the acidic catalyst can be used alone or in combination of two or more kinds, and the above examples of the basic catalyst can be used alone or in combination of two or more kinds.

An amount (total amount) of the acidic catalyst and the basic catalyst added may be 0.1 ppm to 50,000 ppm, 1 ppm to 10,000 ppm, 5 ppm to 1,000 ppm, or 10 ppm to 500 ppm, relative to a total amount of the monomer (A) and the monomer (D). The acidic catalyst and the basic catalyst added in an amount of less than 0.1 ppm hardly function as catalysts. The acidic catalyst and the basic catalyst, when used in a large amount, can reduce the reaction time but tend to be less easily separated and removed from the co-condensation product after a completion of the reaction. A residual acidic catalyst and a residual basic catalyst may reduce the storage stability of the co-condensation product and the present polysiloxane-based resin. As such, considering practicality, the smaller the amount of the acidic catalyst and the basis catalyst, the better, although there should be a balance between practicality and production time.

The mixture in Step 1 of the present production method can contain a diluent solvent as well as the silane compound for dehydrogenation condensation, the water, and the dehydrogenation condensation catalyst. Since the silane compound for dehydrogenation condensation is hydrophobic and water is used during the reaction, the diluent solvent may be water-soluble. There is no limit to the amount of the diluent solvent, but use of the diluent solvent in a large amount reduces the concentration of the polysiloxane obtained and is therefore not preferable from the viewpoint of production costs. Examples of the diluent solvent include: an ether ester such as cellosolve acetate; a ketone such as methyl ethyl ketone, ethyl acetoacetate, acetylacetone, methyl isobutyl ketone, and acetone; an alcohol such as methanol, 2-propanol, n-butanol, isobutanol, hexanol, and octanol. In one or more embodiments of the present invention, the diluent solvent may be an alcohol or 2-propanol.

The radical polymerization initiator in Step 2 is not limited to any particular one, provided that it is a substance that can undergo a radical polymerization reaction with the substance having a radically polymerizable group used in Step 1.

In one or more embodiments of the present invention, examples of the radical polymerization initiator include 2,2′-azobis(isobutyronitrile), 2,2′-azobis(2,4-dimethylvaleronitrile), 2,2′-azobis(2-methylbutyronitrile), tert-butylperoxypivalate, tert-butylperoxybenzoate, tert-butylperoxy-2-ethylhexanoate, di-tert-butyl peroxide, cumene hydroperoxide, and diisopropyl peroxycarbonate.

In one or more embodiments of the present invention, an amount of the radical polymerization initiator may be 0.01% by weight to 10% by weight, 0.05% by weight to 7% by weight, or 0.1% by weight to 5% by weight, relative to 100% by weight of a total amount of the polysiloxane-based resin. In a case where the amount of the radical polymerization initiator is not less than 0.01% by weight, the polymerization proceeds properly. In a case where the amount of the radical polymerization initiator is not more than 10% by weight, it is possible to obtain a polymer having an appropriate molecular weight.

In Step 2 of the present production method, any additive can be added apart from the monomer (B), the monomer (C), the monomer (E), and the radical polymerization initiator, provided that effects of one or more embodiments of the present invention are exhibited. Such an additive can be selected as appropriate by a person skilled in the art.

In the present production method, the monomer (A), the monomer (B), the monomer (C), the monomer (D), and the monomer (E) can be those described above in [2. Polysiloxane-based resin].

In the present production method, the amounts of the respective components can be set as appropriate by a person skilled in the art such that the contents of the “structural unit (a)” through the “structural unit (e)” in the polysiloxane-based resin are within the ranges described above in [2. Polysiloxane-based resin].

In one or more embodiments of the present invention, dehydrogenation condensation and radical polymerization in the present production method can be carried out in a nonaqueous solvent. The nonaqueous solvent used can be, for example, the nonaqueous solvent described above in [3. Resin composition].

In one or more embodiments of the present invention, the present production method may include a step of replacing the nonaqueous solvent with an aqueous solvent after the dehydrogenation condensation and the radical polymerization step. By including the step, it is possible to obtain a polysiloxane-based resin that can be stably dispersed or dissolved in an aqueous medium and can be used as water-based paint.

In one or more embodiments of the present invention, the present production method can be a method described in Examples.

The present polysiloxane-based resin obtained by the present production method is suitably used, for example, as paint or a surface treatment agent for use in: building interiors and exteriors; automobiles as a metallic base, a clear coating on a metallic base, or the like; direct coating on a metal such as aluminum, stainless steel, or silver; direct coating in a ceramic industry such as slates, concrete, roof tiles, mortar, gypsum boards, asbestos slates, asbestos boards, precast concrete, light-weight aerated concrete, calcium silicate boards, tiles, and bricks; glass; and stone materials such as natural marble and granite.

One or more embodiments o the present invention are not limited to the one or more embodiments, but can be altered by a skilled person in the art within the scope of the claims. One or more embodiments of the present invention also encompass, in their technical scope, any embodiments derived by combining technical means disclosed in differing embodiments.

That is, an aspect of one or more embodiments of the present invention encompasses the following.

<1> A polysiloxane-based resin, containing a polymer containing, as a structural unit, a structural unit derived from a monomer having a radically polymerizable group,
the monomer including (i) a monomer that is soluble in water and forms no micelles in water and (ii) a monomer that is capable of forming micelles in water.
   <2> The polysiloxane-based resin as set forth in <1>, wherein:
the (i) monomer that is soluble in water and forms no micelles in water has a salt structure consisting of an acid and a base; and
the (ii) monomer that is capable of forming micelles in water is a monomer having a polyoxyalkylene structure.
   <3> The polysiloxane-based resin as set forth in <1> or <2>, containing:
a structural unit (a) derived from a silane compound (A) that has a radically polymerizable group and a hydrolyzable silyl group;
a structural unit (b) derived from a monomer (B) that has a salt structure consisting of an acid and a base, a radically polymerizable group, and no hydrolyzable silyl group, is soluble in water, and forms no micelles in water;
a structural unit (c) derived from a monomer (C) that has a polyoxyalkylene structure, a radically polymerizable group, and no hydrolyzable silyl group and is capable of forming micelles in water; and
optionally a structural unit (d) derived from a silane compound (D) that is represented by formula (II) below and is other than the (A), the (B), and the (C):

R⁴ₙ—Si—(OR⁵)₄₋ₙ (II)
(where: each R⁴ is independently an unsubstituted or substituted alkyl group having 1 to 10 carbon atoms or an unsubstituted or substituted aryl group, and in a case where there are a plurality of R⁴s, the plurality of R⁴s can be identical to or different from each other; each R⁵ is independently a hydrogen atom or an alkyl group having 1 to 10 carbon atoms; and n is an integer of 0 to 3).
   <4> The polysiloxane-based resin as set forth in any one of <1> to <3>, further containing a structural unit (e) derived from a monomer (E) that has a radically polymerizable group and is other than the (A), the (B), and the (C).
   <5> The polysiloxane-based resin as set forth in <3> or <4>, wherein the structural unit (b) is contained in an amount of 1% by weight to 20% by weight and the structural unit (c) is contained in an amount of 1% by weight to 10% by weight, relative to 100% by weight of a total amount of the polysiloxane-based resin.
   <6> The polysiloxane-based resin as set forth in any one of <3> to <5>, wherein the structural unit (a) and the structural unit (d) are contained in a total amount of not less than 10% by weight, relative to 100% by weight of a total amount of the polysiloxane-based resin.
   <7> A resin composition, containing the polysiloxane-based resin recited in any one of <1> to <6>.
   <8> A solution or dispersion slurry, containing:
the resin composition recited in <7>; and
water serving as a medium.
   <9> Water-based paint, containing:
the resin composition recited in <7>; or
the solution or the dispersion slurry recited in <8>.
   <10> The water-based paint as set forth in <9>, further containing a silicone-based defoaming agent.
   <11> A cured film in the form of:
a cured product of the resin composition recited in <7>; or
a coating of the solution or the dispersion slurry recited in <8> or of the water-based paint recited in <9> or <10>.
   <12> A laminate, including:
an undercoat layer; and
the cured film recited in <11>,
the undercoat layer and the cured film being stacked in this order.

### EXAMPLES

The following description will discuss one or more embodiments of the present invention in more detail with reference to Examples. However, one or more embodiments of the present invention are not limited to these Examples.

[Materials]

The following materials were used in Examples and Comparative Examples.

(Monomer (A))
γ-(meth)acryloxypropyltrimethoxysilane (abbreviated as “TSMA”): “A-174” manufactured by Momentive Performance Materials Japan LLC

(Monomer (B))
Sodium acrylamide-t-butyl sulfonate (abbreviated as “ATBS-Na”): “ATBS-Na” manufactured by TOAGOSEI CO., LTD.

(Monomer (C))
Ether sulfate-type ammonium salt (abbreviated as “SR-10”): “ADEKA REASOAP SR-10” manufactured by ADEKA CORPORATION, which is a compound commercially categorized as “reactive anionic emulsifier” and represented by Formula (A) below:

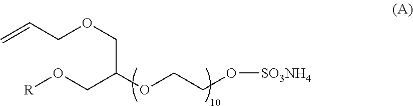

Special nonionic type (abbreviated as “ER-10”): “ADEKA REASOAP ER-10” manufactured by ADEKA CORPORATION, which is a compound commercially categorized as “reactive nonionic emulsifier” and represented by Formula (B) below:

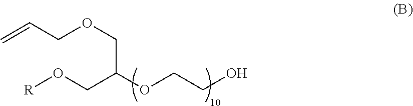

(Monomer (D))
Methyltrimethoxysilane (abbreviated as “M-TMS”): “Z-6033” manufactured by Dow Toray Co., Ltd.
Phenyltrimethoxysilane (abbreviated as “Ph-TMS”): “Z-6124” manufactured by Dow Toray Co., Ltd.

(Monomer (E))
Methyl methacrylate (abbreviated as “MMA”): manufactured by Mitsubishi Gas Chemical Company, Inc.
Butyl acrylate (abbreviated as “BA”): manufactured by Nippon Shokubai Co., Ltd.

<Others>

Pure Water

Dibutyl phosphate: “DBP” manufactured by Johoku Chemical Co., Ltd. 2-propanol: manufactured by Nacalai Tesque, Inc.

Radical polymerization initiator: 2,2′-azobis(2,4-dimethylvaleronitrile): manufactured by Tokyo Chemical Industry Co., Ltd.

(Antifreezing Agent)

Propylene Glycol

(Lubricant)
“Dispex Ultra FA 4437” manufactured by BASF Japan Ltd.

(Dispersing Agent)
“SMA1440H Solution” manufactured by Cray Valley
“Disperbyk-2090” manufactured by BYK Japan KK

(Pigment)
“PFC 105” manufactured by Ishihara Sangyo Kaisha Ltd.

(Preservative)
“Slout 99N” manufactured by Japan EnviroChemicals, Limited

(Defoaming Agent)
Acrylic-based defoaming agent: “Agitan295” manufactured by MUNZING CHEMIE GmbH
Silicone-based defoaming agent (an emulsion of polyether-modified polydimethylsiloxane containing hydrophobic particles): “BYK-1785” manufactured by BYK.
Silicone-based defoaming agent (an emulsion of polyether-modified polydimethylsiloxane containing hydrophobic particles): “BYK-019” manufactured by BYK.
Silicone-based defoaming agent (an emulsion of polyether-modified polydimethylsiloxane containing hydrophobic particles): “BYK-1770” manufactured by BYK.
Silicone-based defoaming agent (an emulsion of hydrophobic particles and foam-breaking polysiloxane): “BYK-1786” manufactured by BYK.
Silicone-based defoaming agent (a mixture of foam-breaking polysiloxane and hydrophobic particles in polyglycol: “BYK-093” manufactured by BYK.
Silicone-based defoaming agent (a mixture of foam-breaking polysiloxane and hydrophobic particles in polyglycol: “BYK-024” manufactured by BYK.

(Film Foaming Aid)
2,2,4-trimethyl-1.3-pentanediol monoisobutyrate: “CS-12” manufactured by JNC Corporation

(Thickener)
“SN thickener 612NC” manufactured by San Nopco Limited

(Anti-Fungal and Anti-Algae Agent)
“MONICIDE AZ” manufactured by Japan EnviroChemicals, Limited

(Hydrophilization Agent)
“Silicate 40” manufactured by TAMA CHEMICALS CO., LTD.

(Curing Catalyst)
“U-220H” manufactured by Nitto Chemical Industry Co., Ltd.

[Measurement and Evaluation Methods]

In Examples and Comparative Examples, measurement and evaluation were carried out by the following methods.

(Stability)

The polysiloxane-based resin was diluted with water so as to have a volatile component content of 50%. At this time, visual observation of the diluted polysiloxane-based resin was made to evaluate stability. A case in which the polysiloxane-based resin was stably dispersed or dissolved in the water was evaluated to be “good”, and a case in which a phase separation between the polysiloxane-based resin and the water and/or a precipitate of the polysiloxane-based resin were/was observed was evaluated to be “poor”.

(Viscosity)

The polysiloxane-based resin was diluted with water so as to have a volatile component content of 50%. A viscosity of the solution containing the polysiloxane-based resin was measured with use of a BM-type viscometer (Rotor No. 2, 6 rpm) at 23° C.

(Weather Resistance (Gloss Retention))

With reference to International Publication No. WO 2016/052636 and U.S. Pat. No. 5,555,449, a cured film obtained by curing water-based paint containing the obtained polysiloxane-based resin was evaluated in terms of weather resistance.

To describe briefly, a metal halide lamp-type tester (model number: KU-R⁵CI-A, manufactured by DAIPLA WINTES CO., LTD.) was used to carry out an accelerated weathering test of a specimen (a cured film on a specimen) prepared by a method described later. A gloss value at 600 of the specimen was measured 400 hours before and after the accelerated weathering test, and a gloss retention was calculated. The higher the gloss retention, the better the weather resistance.

The test conditions for the accelerated weathering test are as follows.
Illuminance: 85 mW/cm²
Irradiation: 63° C., 50%, 6 hours
Condensation: 30° C., 98%, 2 hours
Shower: 30 seconds before and after the condensation

### Example 1

(Preparation of Co-Condensation Product (Main Chain))

To a reactor including a stirrer, a thermometer, and a reflux condenser, 2.7 parts by weight of TSMA, 42.2 parts by weight of M-TMS, 14.7 parts by weight of Ph-TMS, 15.4 parts by weight of pure water, and 0.017 parts by weight of DBP were introduced and caused to react for 3 hours at a reaction temperature of 105° C. while being stirred. Thus obtained was a co-condensation product.

(Preparation of Graft Co-Condensation Product (Polymerization of Side Chains))

To a reactor including a stirrer, a thermometer, a reflux condenser, a nitrogen gas inlet tube, and a dropping funnel, 10 parts by weight of pure water and 15 parts by weight of 2-propanol were introduced, and the temperature was raised to 75° C. while introducing nitrogen gas. Then, a mixed solution of the co-condensation product, 5 parts by weight of ATBS-Na, 1 part by weight of SR-10, 32 parts by weight of MMA, 32 parts by weight of BA, 1.2 parts by weight of 2,2-azobis(2,4-dimethylvaleronitrile), 10 parts by weight of pure water, and 10 parts by weight of 2-propanol was dropped from the dropping funnel at a constant rate for 5 hours. Subsequently, a mixed solution of 0.12 parts by weight of 2,2-azobis(2,4-dimethylvaleronitrile) and 5 parts by weight of 2-propanol was dropped at a constant rate for one hour. Then, the mixed solution was stirred for 2 hours at 75° C., and then deaeration was carried out with use of a rotary evaporator until a nonvolatile component accounted for not less than 90%. Subsequently, the resultant product was diluted with water so that the nonvolatile component accounted for 50%. The resultant product was cooled to room temperature to obtain a graft co-condensation product (polysiloxane-based resin). The obtained polysiloxane-based resin was subjected to measurement of stability and viscosity by the above method. Table 1 shows the results. In Table 1, an amount of each component is indicated by the unit of “parts by weight”.

### Examples 2 to 5 and Comparative Examples 1 to 4

A graft co-condensation product (polysiloxane-based resin) was obtained by a method similar to that of Example 1, except that amounts of monomers used were changed to amounts indicated in Table 1. The obtained polysiloxane-based resin was subjected to measurement of stability and viscosity. Table 1 shows the results.

TABLE 1

| | | | | | | | | Compar- | Compar- | Compar- | Compar- |
|---|---|---|---|---|---|---|---|---|---|---|---|
| | | | | | | | | ative | ative | ative | ative |
| | | | Exam- | Exam- | Exam- | Exam- | Exam- | Exam- | Exam- | Exam- | Exam- |
| | | | ple 1 | ple 2 | ple 3 | ple 4 | ple 5 | ple 1 | ple 2 | ple 3 | ple 4 |
| Systhesis | Monomer (A) | TSMA | 2.7 | 2.7 | 2.7 | 2.7 | 2.7 | 2.7 | 2.7 | 2.7 | 2.7 |
| formulation | Monomer (B) | ATBS-Na | 5 | 5 | 5 | 6 | 5 | — | — | 6 | 10 |
| | Monomer (C) | SR-10 | 1 | 5 | 7 | 2 | — | 6 | 10 | — | — |
| | | ER-10 | — | — | — | — | 1 | — | — | — | — |
| | Monomer (D) | M-TMS | 42.2 | 42.2 | 42.2 | 42.2 | 42.2 | 42.2 | 42.2 | 42.2 | 42.2 |
| | | Ph-TMS | 14.7 | 14.7 | 14.7 | 14.7 | 14.7 | 14.7 | 14.7 | 14.7 | 14.7 |
| | Monomer (E) | MMA | 32 | 30 | 29 | 31 | 32 | 32 | 30 | 32 | 30 |
| | | BA | 32 | 30 | 29 | 31 | 32 | 32 | 30 | 32 | 30 |

| | | | | | | | | | | |
|---|---|---|---|---|---|---|---|---|---|---|
| Evaluation | Stability | Good | Good | Good | Good | Good | Poor | Poor | Poor | Good |
| result | Viscosity (mPa · s) | 1,450 | 1,200 | 1,150 | 3,150 | 1,300 | — | — | 8,500 | 22,000 |

[Results]

As indicated in Table 1, the polysiloxane-based resins of Examples 1 to 5 exhibited good results in stability and viscosity. That is, it was indicated that, according to one or more embodiments of the present invention, it is possible to provide a polysiloxane-based resin that can be stably dispersed or dissolved in an aqueous medium and has an appropriate level of viscosity.

In contrast, the polysiloxane-based resins of Comparative Examples 1 to 3 showed precipitation in the aqueous medium and thus exhibited poor results in stability. The polysiloxane-based resins of Comparative Examples 3 and 4 exhibited excellent results in viscosity.

### Examples 6 to 23

(Preparation of Water-Based Paint)

With use of the polysiloxane-based resins of Examples 1 to 5, water-based paints (white paints serving as main agents) were prepared by blending components in accordance with blending formulas indicated in Table 2 or 3.

(Preparation of Cured Film)

Each of the prepared water-based paints was applied to glass with use of an applicator having a coating film thickness of 6 mils, and was cured for 1 week at a temperature of 23° C. and a humidity of 50% to prepare a coating film (cured film).

(Appearance of Coating Film)

The appearance of the coating film prepared through the above step was visually evaluated. A case in which no crack, wrinkle, stripping, or development of a matting was observed was evaluated to be “good”, and a case in which a crack, wrinkle, peeling, or development of a matting was observed was evaluated to be “poor”.

TABLE 2

| Step | Added agent | Product name | Manufacturer | Example 6 | Example 7 | Example 8 | Example 9 | Example 10 | Example 11 | Example 12 | Example 13 | Example 14 |
|---|---|---|---|---|---|---|---|---|---|---|---|---|
| Millbase | Water | | | 4.80 | 4.80 | 4.80 | 4.80 | 4.80 | 4.80 | 4.80 | 4.80 | 4.80 |
| | Antifreezing agent | Propylene glycol | Reagent | 2.00 | 2.00 | 2.00 | 2.00 | 2.00 | 2.00 | 2.00 | 2.00 | 2.00 |
| | Wetting agent | Displex Ultra FA 4437 | BASF Japan Ltd. | 0.50 | 0.50 | 0.50 | 0.50 | 0.50 | 0.50 | 0.50 | 0.50 | 0.50 |
| | Dispersing agent | SMA1440H Solution | Cray Valley | 0.70 | 0.70 | 0.70 | 0.70 | 0.70 | 0.70 | 0.70 | 0.70 | 0.70 |
| | | Disperbyk-2090 | BYK Japan KK | 0.50 | 0.50 | 0.50 | 0.50 | 0.50 | 0.50 | 0.50 | 0.50 | 0.50 |
| | Pigment | PFC105 | Ishihara Sangyo | 20.20 | 20.20 | 20.20 | 20.20 | 20.20 | 20.20 | 20.20 | 20.20 | 20.20 |
| | | | Kaisha Ltd. | | | | | | | | | |
| | Preservative | Slout 99N | Japan | 0.20 | 0.20 | 0.20 | 0.20 | 0.20 | 0.20 | 0.20 | 0.20 | 0.20 |
| | | | EnviroChemicals, | | | | | | | | | |
| | | | Limited | | | | | | | | | |
| | Defoaming agent | Agitan295 | MUNZING CHEMIE | 0.10 | 0.10 | 0.10 | 0.10 | 0.10 | 0.10 | 0.10 | 0.10 | 0.10 |
| | | | GmbH | | | | | | | | | |
| Cutback | Resin | Polysiloxane-based | — | 60.00 | | | | | 60.00 | 60.00 | 60.00 | 60.00 |
| | | resin of Example 1 | | | | | | | | | | |
| | | Polysiloxane-based | — | | 60.00 | | | | | | | |
| | | resin of Example 2 | | | | | | | | | | |
| | | Polysiloxane-based | — | | | 60.00 | | | | | | |
| | | resin of Example 3 | | | | | | | | | | |
| | | Polysiloxane-based | — | | | | 60.00 | | | | | |
| | | resin of Example 4 | | | | | | | | | | |
| | | Polysiloxane-based | — | | | | | 60.00 | | | | |
| | | resin of Example 5 | | | | | | | | | | |
| | Film foaming aid | CS-12 | JNC | 6.00 | 6.00 | 6.00 | 6.00 | 6.00 | 6.00 | 6.00 | 6.00 | 6.00 |
| | Thickener | SN thickener 612NC | San Nopco Limited | 0.30 | 0.30 | 0.30 | 0.30 | 0.30 | 0.30 | 0.30 | 0.30 | 0.30 |
| | Anti-fungal and | MONICIDE AZ | Japan | 0.50 | 0.50 | 0.50 | 0.50 | 0.50 | 0.50 | 0.50 | 0.50 | 0.50 |
| | anti-algae agent | | EnviroChemicals, | | | | | | | | | |
| | | | Limited | | | | | | | | | |
| | Defoaming agent | Agitan295 | MUNZING CHEMIE | 0.20 | 0.20 | 0.20 | 0.20 | 0.20 | 1.50 | | | |
| | | | GmbH | | | | | | | | | |
| | | BYK-1785 | BYK | | | | | | | 0.20 | 1.50 | |
| | | BYK-019 | BYK | | | | | | | | | 0.20 |
| | | BYK-1770 | BYK | | | | | | | | | |
| | | BYK-1786 | BYK | | | | | | | | | |
| | | BYK-093 | BYK | | | | | | | | | |
| | | BYK-024 | BYK | | | | | | | | | |

| | | | | | | | | | |
|---|---|---|---|---|---|---|---|---|---|
| Water | 4.00 | 4.00 | 4.00 | 4.00 | 4.00 | 2.70 | 4.00 | 2.70 | 4.00 |

| | | | | | | | | | |
|---|---|---|---|---|---|---|---|---|---|
| Total | 100.00 | 100.00 | 100.00 | 100.00 | 100.00 | 100.00 | 100.00 | 100.00 | 100.00 |
| Appearance of coating film | Good | Good | Good | Good | Good | Good | Good | Good | Good |

TABLE 3

| Step | Added agent | Product name | Manufacturer | Example 15 | Example 16 | Example 17 | Example 18 | Example 19 | Example 20 | Example 21 | Example 22 | Example 23 |
|---|---|---|---|---|---|---|---|---|---|---|---|---|
| Millbase | Water | | | 4.80 | 4.80 | 4.80 | 4.80 | 4.80 | 4.80 | 4.80 | 4.80 | 4.80 |
| | Antifreezing agent | Propylene glycol | Reagent | 2.00 | 2.00 | 2.00 | 2.00 | 2.00 | 2.00 | 2.00 | 2.00 | 2.00 |
| | Wetting agent | Displex Ultra FA 4437 | BASF Japan Ltd. | 0.50 | 0.50 | 0.50 | 0.50 | 0.50 | 0.50 | 0.50 | 0.50 | 0.50 |
| | Dispersing agent | SMA1440H Solution | Cray Valley | 0.70 | 0.70 | 0.70 | 0.70 | 0.70 | 0.70 | 0.70 | 0.70 | 0.70 |
| | | Disperbyk-2090 | BYK Japan KK | 0.50 | 0.50 | 0.50 | 0.50 | 0.50 | 0.50 | 0.50 | 0.50 | 0.50 |
| | Pigment | PFC105 | Ishihara Sangyo | 20.20 | 20.20 | 20.20 | 20.20 | 20.20 | 20.20 | 20.20 | 20.20 | 20.20 |
| | | | Kaisha Ltd. | | | | | | | | | |
| | Preservative | Slout 99N | Japan | 0.20 | 0.20 | 0.20 | 0.20 | 0.20 | 0.20 | 0.20 | 0.20 | 0.20 |
| | | | EnviroChemicals, | | | | | | | | | |
| | | | Limited | | | | | | | | | |
| | Defoaming agent | Agitan295 | MUNZING CHEMIE | 0.10 | 0.10 | 0.10 | 0.10 | 0.10 | 0.10 | 0.10 | 0.10 | 0.10 |
| | | | GmbH | | | | | | | | | |
| Cutback | Resin | Polysiloxane-based | — | 60.00 | 60.00 | 60.00 | 60.00 | 60.00 | 60.00 | 60.00 | 60.00 | 60.00 |
| | | resin of Example 1 | | | | | | | | | | |
| | | Polysiloxane-based | — | | | | | | | | | |
| | | resin of Example 2 | | | | | | | | | | |
| | | Polysiloxane-based | — | | | | | | | | | |
| | | resin of Example 3 | | | | | | | | | | |
| | | Polysiloxane-based | — | | | | | | | | | |
| | | resin of Example 4 | | | | | | | | | | |
| | | Polysiloxane-based | — | | | | | | | | | |
| | | resin of Example 5 | | | | | | | | | | |
| | Film foaming aid | CS-12 | JNC | 6.00 | 6.00 | 6.00 | 6.00 | 6.00 | 6.00 | 6.00 | 6.00 | 6.00 |
| | Thickener | SN thickener 612NC | San Nopco Limited | 0.30 | 0.30 | 0.30 | 0.30 | 0.30 | 0.30 | 0.30 | 0.30 | 0.30 |
| | Anti-fungal and | MONICIDE AZ | Japan | 0.50 | 0.50 | 0.50 | 0.50 | 0.50 | 0.50 | 0.50 | 0.50 | 0.50 |
| | anti-algae agent | | EnviroChemicals, | | | | | | | | | |
| | | | Limited | | | | | | | | | |
| | Defoaming agent | Agitan295 | MUNZING CHEMIE | | | | | | | | | |
| | | | GmbH | | | | | | | | | |
| | | BYK-1785 | BYK | | | | | | | | | |
| | | BYK-019 | BYK | 1.50 | | | | | | | | |
| | | BYK-1770 | BYK | | 0.20 | 1.50 | | | | | | |
| | | BYK-1786 | BYK | | | | 0.20 | 1.50 | | | | |
| | | BYK-093 | BYK | | | | | | 0.20 | 1.50 | | |
| | | BYK-024 | BYK | | | | | | | | 0.20 | 1.50 |

| | | | | | | | | | |
|---|---|---|---|---|---|---|---|---|---|
| Water | 2.70 | 4.00 | 2.70 | 4.00 | 2.70 | 4.00 | 2.70 | 4.00 | 2.70 |

| | | | | | | | | | |
|---|---|---|---|---|---|---|---|---|---|
| Total | 100.00 | 100.00 | 100.00 | 100.00 | 100.00 | 100.00 | 100.00 | 100.00 | 100.00 |
| Appearance of coating film | Good | Good | Good | Good | Good | Good | Good | Good | Good |

### Examples 24 to 37

(Preparation of Cured Film)

With reference to International Publication No. WO 2016/052636, cured films were prepared with use of water-based paints of Examples 6 to 10, 12, and 13, and a weather resistance of each of the cured films was measured. To describe briefly, onto the surface of a primer layer of an aluminum plate (50 mm×150 mm) on which HI-PON FINE PRIMER II (manufactured by Nippon Paint Co., Ltd.) had been applied as a primer, water-based paint which had been prepared in accordance with a blending formula indicated in Table 4 or 5 was applied with use of an air spray so as to achieve a dry film thickness (a film thickness of a cured film which had been dried) of approximately 40 μm, and the water-based paint was dried for 4 hours at 23° C. and 50% RH (first application). Further, onto the dry film obtained through the first application, the water-based paint was applied again with use of an air spray so as to achieve a dry film thickness of approximately 40 μm (i.e., so that the cured film which had been dried on the primer layer had a total film thickness of 80 μm). The resultant product was then dried at 23° C. and 50% RH for 1 week (second application). By this operation, a laminate was obtained in which the primer layer and the cured film were stacked in this order in the form of an aluminum plate which served as a base material. The obtained laminate was used as a specimen to measure a weather resistance of the cured film. The results are shown in Table 4 or 5.

TABLE 4

| | | | Exam- | Exam- | Exam- | Exam- | Exam- | Exam- | Exam- |
|---|---|---|---|---|---|---|---|---|---|
| Added agent | Product name | Manufacturer | ple 24 | ple 25 | ple 26 | ple 27 | ple 28 | ple 29 | ple 30 |
| Main agent | Example 6 | | 100.00 | | | | | | |
| | Example 7 | | | 100.00 | | | | | |
| | Example 8 | | | | 100.00 | | | | |
| | Example 9 | | | | | 100.00 | | | |
| | Example 10 | | | | | | 100.00 | | |
| | Example 12 | | | | | | | 100.00 | |
| | Example 13 | | | | | | | | 100.00 |
| Hydrophilization | Silicate 40 | TAMA CHEMICALS | | | | | | | |
| agent | | CO., LTD. | | | | | | | |
| Catalyst | U-220H | Nitto Chemical | | | | | | | |
| | | Industry Co., Ltd. | | | | | | | |

| | | | | | | | |
|---|---|---|---|---|---|---|---|
| Gloss retention | 98% | 98% | 97% | 99% | 99% | 99% | 99% |

TABLE 5

| | | | Exam- | Exam- | Exam- | Exam- | Exam- | Exam- | Exam- |
|---|---|---|---|---|---|---|---|---|---|
| Added agent | Product name | Manufacturer | ple 31 | ple 32 | ple 33 | ple 34 | ple 35 | ple 36 | ple 37 |
| Main agent | Example 6 | | 100.00 | | | | | | |
| | Example 7 | | | 100.00 | | | | | |
| | Example 8 | | | | 100.00 | | | | |
| | Example 9 | | | | | 100.00 | | | |
| | Example 10 | | | | | | 100.00 | | |
| | Example 12 | | | | | | | 100.00 | |
| | Example 13 | | | | | | | | 100.00 |
| Hydrophilization | Silicate 40 | TAMA CHEMICALS | 3.00 | 3.00 | 3.00 | 3.00 | 3.00 | 3.00 | 3.00 |
| agent | | CO., LTD. | | | | | | | |
| Catalyst | U-220H | Nitto Chemical | 0.10 | 0.10 | 0.10 | 0.10 | 0.10 | 0.10 | 0.10 |
| | | Industry Co., Ltd. | | | | | | | |

| | | | | | | | |
|---|---|---|---|---|---|---|---|
| Gloss retention | 97% | 98% | 99% | 96% | 99% | 99% | 99% |

The present polysiloxane-based resin can be stably dispersed or dissolved in an aqueous medium and, when used as water-based paint, has an appropriate level of viscosity. Thus, the present polysiloxane-based resin can be suitably utilized in the field of various coating agents and the like.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A polysiloxane-based resin, comprising a polymer containing, as a structural unit, a structural unit derived from a monomer having a radically polymerizable group,
wherein:
the monomer includes (i) a monomer that is soluble in water and forms no micelles in water and (ii) a monomer that is capable of forming micelles in water;
the (i) monomer that is soluble in water and forms no micelles in water has a salt structure consisting of an acid and a base; and
the polysiloxane-based resin contains a structural unit (d) derived from a silane compound (D) that is represented by formula (II) below:
R⁴ₙ—Si—(OR⁵)₄₋ₙ (II),
where:
each R⁴ is independently an unsubstituted or substituted alkyl group having 1 to 10 carbon atoms or an unsubstituted or substituted aryl group, and in a case where there are a plurality of R⁴s, the plurality of R⁴s can be identical to or different from each other;
each R⁵ is independently a hydrogen atom or an alkyl group having 1 to 10 carbon atoms; and
n is an integer of 0 to 3.

2. The polysiloxane-based resin as set forth in claim 1, wherein the (ii) monomer that is capable of forming the micelles in water is a monomer having a polyoxyalkylene structure.

3. The polysiloxane-based resin as set forth in claim 1, containing:
a structural unit (a) derived from a silane compound (A) that has a radically polymerizable unsaturated group and a hydrolyzable silyl group;
a structural unit (b) derived from a monomer (B) that has a salt structure consisting of an acid and a base, a radically polymerizable group, and no hydrolyzable silyl group, is soluble in water, and forms no micelles in water; and
a structural unit (c) derived from a monomer (C) that has a polyoxyalkylene structure, a radically polymerizable group, and no hydrolyzable silyl group and is capable of forming micelles in water.

4. The polysiloxane-based resin as set forth in claim 3, further containing a structural unit (e) derived from a monomer (E) that has a radically polymerizable group and is other than the (A), the (B), and the (C).

5. The polysiloxane-based resin as set forth in claim 3, wherein the structural unit (b) is contained in an amount of 1% by weight to 20% by weight and the structural unit (c) is contained in an amount of 1% by weight to 10% by weight, relative to 100% by weight of a total amount of the polysiloxane-based resin.

6. The polysiloxane-based resin as set forth in claim 3, wherein the structural unit (a) and the structural unit (d) are contained in a total amount of not less than 10% by weight, relative to 100% by weight of a total amount of the polysiloxane-based resin.

7. A resin composition, comprising the polysiloxane-based resin recited in claim 1.

8. A solution or dispersion slurry, comprising:
the resin composition recited in claim 7; and
water serving as a medium.

9. Water-based paint, comprising the resin composition recited in claim 7.

10. Water-based paint, comprising the solution or dispersion slurry recited in claim 8.

11. The water-based paint as set forth in claim 9, further comprising a silicone-based defoaming agent.

12. The water-based paint as set forth in claim 10, further comprising a silicone-based defoaming agent.
